(19) United States
(12) Patent Application Publication
(10) Pub. No.: US 2024/0096081 A1
(43) Pub. Date: Mar. 21, 2024

(54) NEURAL NETWORK TRAINING METHOD

(71) Applicant: INFINITESIMA LIMITED, Abingdon (GB)

(72) Inventors: Andrew Humphris, Abingdon (GB); Patrick Hole, Whitchurch (GB); Hamish Rogers, Abingdon (GB); Iwan Mitchell, Bangor (GB)

(21) Appl. No.: 18/368,151

(22) Filed: Sep. 14, 2023

(30) Foreign Application Priority Data
Sep. 15, 2022 (GB) 2213576.8

(51) Int. Cl. G06V 10/82; G06T 3/40; G06T 3/60; G06T 7/11; G06T 7/62; G06V 10/44; G06V 10/60

(52) U.S. Cl. CPC G06V 10/82; G06T 3/40; G06T 3/60; G06T 7/11; G06T 7/62; G06V 10/44; G06V 10/60; G06T 2207/20081

(57) ABSTRACT

A method of training a neural network for use in surface metrology includes providing height image data comprising a series of height measurements of a sample, the height image data comprising a plurality of features; obtaining, from the height image data, a plurality of height image patches, each height image patch containing at least a portion of a feature. The method also includes applying one or more effects to each of the height image patches to obtain a corresponding modified height image patch for each height image patch and inputting one or more of the modified height image patches into the neural network. The method further includes using the neural network to identify a feature in each of the one or more modified height image patches and training the neural network based on the identification.

### FIELD OF THE INVENTION

The present invention relates to a method, apparatus and computer program for training a neural network

### BACKGROUND OF THE INVENTION

When measuring samples using a scanning probe microscope, it is often important to accurately measure features of these samples, such as the height of a protrusion or the depth of a depression. To measure height for example, it is necessary to measure a point of the feature relative to a “ground” level of the sample. To do this efficiently, and accurately on an automated basis, it is important to be able to reliably identify the feature, as well as suitable “ground” points in the image (i.e. those positions not relating to a feature or abnormality). This can be done using a neural network. There is therefore a need to train the neural network to be able to perform this function.

### SUMMARY OF THE INVENTION

A first aspect of the invention provides a method of training a neural network for use in surface metrology, comprising: providing height image data comprising a series of height measurements of a sample, the height image data comprising a plurality of features; obtaining, from the height image data, a plurality of height image patches, each height image patch containing at least a portion of a feature; applying one or more effects to each of the height image patches to obtain a corresponding modified height image patch for each height image patch; inputting one or more of the modified height image patches into the neural network; using the neural network to identify a feature in each of the one or more modified height image patches; and training the neural network based on the identification.

The height image data may comprise real data obtained from a real sample. For example the height image data may comprise real data obtained from a real sample by scanning the real sample with a probe microscope. Additionally or alternatively, the height image data may comprise simulated data.

The one or more effects may comprise at least one of: a rotation; a reflection; applying noise; raising or lowering brightness; raising or lowering contrast; zooming in; and zooming out.

The plurality of height image patches may comprise 10000 height image patches. The plurality of height image patches may comprise 15000 height image patches.

The neural network may be trained based on each of the modified height image patches.

Each height image patch may comprise at least a corner, edge or central portion of a feature.

The method may further comprise: obtaining, from the height image data, a plurality of additional height image patches that do not contain a feature or a portion of a feature; applying one or more effects to each of the additional height image patches to obtain a corresponding modified additional height image patch for each additional height image patch; inputting one or more of the modified additional height image patches into the neural network; using the neural network to determine that there are no features in each of the one or more modified additional height image patches; and training the neural network based on the determination.

Optionally each height image patch comprises height measurements of an area of a surface of the sample.

Optionally the method further comprises: obtaining, from the height image data, height image patches which do not contain a portion of a feature.

Optionally a plurality of the features have at least a portion of the feature contained in at least one of the height image patches.

Optionally some of the height image patches contain an entire feature and some of the height image patches contain a portion of a feature.

A second aspect of the invention provides apparatus for training a neural network for use in surface metrology, comprising a processor configured to perform the method of the first aspect.

A third aspect of the invention provides a method of performing surface metrology of a sample, the method comprising: training a neural network by a method according to the first aspect, thereby generating a trained neural network; scanning a new sample to obtain a series of height measurements of the new sample; and operating the trained neural network to identify feature data in the series of height measurements of the new sample.

A fourth aspect of the invention provides a computer-readable medium that, when read by a computer, causes the computer to perform the method of the first aspect.

### BRIEF DESCRIPTION OF THE DRAWINGS

Embodiments of the invention will now be described with reference to the accompanying drawings, in which:

FIG. 1 shows a scanning probe microscopy system according to an embodiment of the invention;

FIG. 2 shows a measurement system in accordance with an embodiment of the invention;

FIGS. 3A-C show the generation of modified height image patches;

FIG. 4 shows use of modified height image patches to train a neural network;

FIGS. 5A-C show sample segmentation and mask generation according to embodiments of the invention;

FIGS. 6A-C show sample segmentation and mask generation according to embodiments of the invention;

FIG. 7 shows a method of training a neural network;

FIGS. 8A-C show a comparison of classical segmentation results versus segmentation according to embodiments of the invention; and

FIG. 9 shows a method of training a neural network according to embodiments of the invention.

### DETAILED DESCRIPTION OF EMBODIMENT(S)

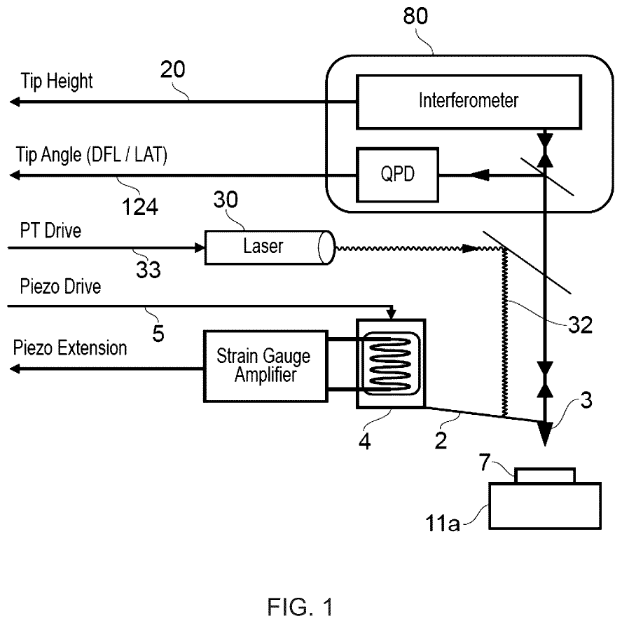

A scanning probe microscopy system according to an embodiment of the invention is shown in FIG. 1. The system comprises a piezoelectric driver 4 and a probe comprising a cantilever 2 and a probe tip 3. The bottom of the piezoelectric driver 4 provides a cantilever mount, with the cantilever 2 extending from the cantilever mount from a proximal end or base to a distal free end. The probe tip 3 is carried by the free end of the cantilever 2.

The probe tip 3 comprises a conical or pyramidal structure that tapers from its base to a point at its distal end that is its closest point of interaction with a sample 7 on a sample stage 11a. The sample comprises a sample surface which defines a sample surface axis which is normal to the sample surface and in FIG. 1 also extends vertically. The cantilever 2 comprises a single beam with a rectangular profile extending from the cantilever mount 13. The cantilever 2 has a length of about 20 micron, a width of about 10 micron, and a thickness of about 200 nm.

In this example the probe tip 3 tapers to a point, but in other embodiments the probe tip 3 may be specially adapted for measuring sidewalls. For instance the probe tip 3 may have a flared shape.

The cantilever 2 is a thermal bimorph structure composed of two (or more) materials, with differing thermal expansion coefficients—typically a silicon or silicon nitride base with a gold or aluminium coating. The coating extends the length of the cantilever and covers the reverse side from the tip 3. An illumination system (in the form of a laser 30) under the control of photothermal (PT) drive 33 is arranged to illuminate the cantilever on its upper coated side with an intensity-modulated radiation spot.

The cantilever 2 is formed from a monolithic structure with uniform thickness. For example the monolithic structure may be formed by selectively etching a thin film of SiO₂ or SiN₄ as described in Albrecht T., Akamine, S., Carver, T. E., Quate, C. F. J., Microfabrication of cantilever styli for the atomic force microscope, Vac. Sci. Technol. A 1990, 8, 3386 (hereinafter referred to as “Albrecht et al.”). The tip 3 may be formed integrally with the cantilever, as described in Albrecht et al., it may be formed by an additive process such as electron beam deposition, or it may be formed separately and attached by adhesive or some other attachment method.

The wavelength of the actuation beam 32 output by the laser 30 is selected for good absorption by the coating, so that the cantilever 2 bends along its length and moves the probe tip 3. In this example the coating is on the reverse side from the sample so the cantilever 2 bends down towards the sample when heated, but alternatively the coating may be on the same side as the sample so the cantilever 2 bends away from the sample when heated.

The piezoelectric driver 4 expands and contracts up and down in the Z-direction in accordance with a piezo drive signal 5 at a piezo driver input. As described further below, the piezo drive signal 5 causes the piezoelectric driver 4 to move the probe repeatedly towards and away from the sample 7 in a series of cycles. The piezo drive signal 5 is generated by a piezo controller (not shown). Typically the piezoelectric driver 4 is mechanically guided by flexures (not shown).

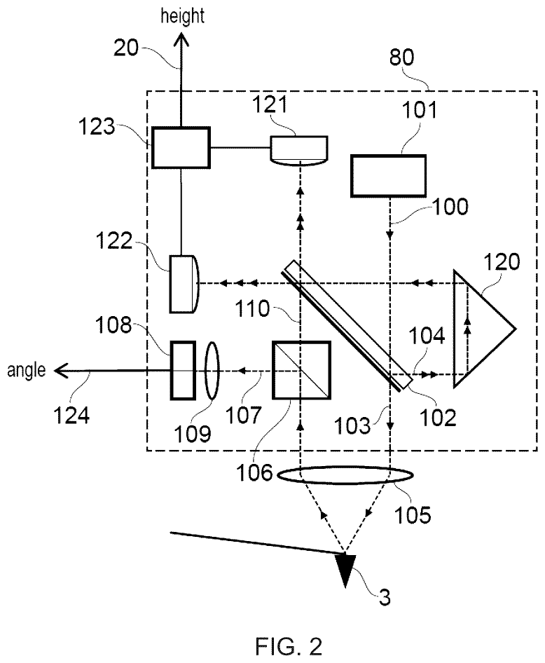

A measurement system 80 is arranged to detect a height of the free end of the cantilever 2 directly opposite to the probe tip 3. The measurement system 80 includes an interferometer and a quadrant photodiode (QPD). FIG. 1 only shows the measurement system 80 schematically and FIG. 2 gives a more detailed view. Light 100 from a laser 101 is split by a beam splitter 102 into a sensing beam 103 and a reference beam 104. The reference beam 104 is directed onto a suitably positioned retro-reflector 120 and thereafter back to the beam splitter 102. The retro-reflector 120 is aligned such that it provides a fixed optical path length relative to the vertical (Z) position of the sample 7. The beam splitter 102 has an energy absorbing coating and splits both the incident 103 and reference 104 beams to produce first and second interferograms with a relative phase shift of 90 degrees. The two interferograms are detected respectively at first 121 and second 122 photodetectors.

Ideally, the outputs from the photodetectors 121, 122 are complementary sine and cosine signals with a phase difference of 90 degrees. Further, they should have no dc offset, have equal amplitudes and only depend on the position of the cantilever and wavelength of the laser 101. Known methods are used to monitor the outputs of the photodetectors 121, 122 while changing the optical path difference in order to determine and to apply corrections for errors arising as a result of the two photodetector outputs not being perfectly harmonic, with equal amplitude and in phase quadrature. Similarly, dc offset levels are also corrected in accordance with methods known in the art.

These photodetector outputs are suitable for use with a conventional interferometer reversible fringe counting apparatus and fringe subdividing apparatus 123, which may be provided as dedicated hardware, FPGA, DSP or as a programmed computer. Phase quadrature fringe counting apparatus is capable of measuring displacements in the position of the cantilever to an accuracy of λ/8. That is, to 66 nm for 532 nm light.

Known fringe subdividing techniques, based on the arc tangent of the signals, permit an improvement in accuracy to the nanometre scale or less. In the embodiment described above, the reference beam 104 is arranged to have a fixed optical path length relative to the Z position of the sample 7. It could accordingly be reflected from the surface of the stage 11a on which the sample 7 is mounted or from a retro-reflector whose position is linked to that of the stage. The reference path length may be greater than or smaller than the length of the path followed by the beam 103 reflected from the probe. Alternatively, the relationship between reflector and sample Z position does not have to be fixed. In such an embodiment the reference beam may be reflected from a fixed point, the fixed point having a known (but varying) relationship with the Z position of the sample. The height of the tip is therefore deduced from the interferometrically measured path difference and the Z position of the sample with respect to the fixed point.

The interferometer detector is one example of a homodyne system. The particular system described offers a number of advantages to this application. The use of two phase quadrature interferograms enables the measurement of cantilever displacement over multiple fringes, and hence over a large displacement range. Examples of an interferometer based on these principles are described in U.S. Pat. No. 6,678,056 and WO2010/067129. Alternative interferometer systems capable of measuring a change in optical path length may also be employed. A suitable homodyne polarisation interferometer is described in EP 1 892 727 and a suitable heterodyne interferometer is described in U.S. Pat. No. 5,144,150.

Returning to FIG. 1, the output of the interferometer is a height signal on a height detection line 20 which is input to a surface height calculator (not shown) and a surface detection unit (not shown). The surface detection unit is arranged to generate a surface signal on a surface detector output line for each cycle when it detects an interaction of the probe tip 3 with the sample 7.

The reflected beam is also split by a beam splitter 106 into first and second components 107, 110. The first component 107 is directed to a segmented quadrant photodiode 108 via a lens 109, and the second component 110 is split by the beam splitter 102 and directed to the photodiodes 121, 122 for generation of the height signal on the output line 20. The photodiode 108 generates angle data 124 which is indicative of the position of the first component 107 of the reflected beam on the photodiode 108, and varies in accordance with the angle of inclination of the cantilever relative to the sensing beam 103.

The angle data 124 comprises a deflection/bending signal which indicates a flexural angle of the cantilever—i.e. an angle which changes as the cantilever bends along its length. Thus the deflection/bending signal is indicative of the flexural shape of the cantilever. The deflection/bending signal may be determined in accordance with a difference between the signals from the top and bottom halves of the quadrant photodiode 108.

The angle data 124 also comprises a lateral/twisting signal which indicates a torsion angle of the cantilever—i.e. an angle which changes as the cantilever twists. Thus the lateral/twisting signal is indicative of the torsional shape of the cantilever. The lateral/twisting signal may be determined in accordance with a difference between the signals from the left and right halves of the quadrant photodiode 108.

The scanning probe microscopy system described above is used to scan a sample to obtain probe microscope data in the form of a series of height image data. The sample comprises a plurality of features. A feature in the sample is simply an abnormality of the sample, optionally having a height dimension that notably deviates from a mean or mode height dimension across the sample. The features may be columns or wells, for example. Features correspond to feature data within height image data.

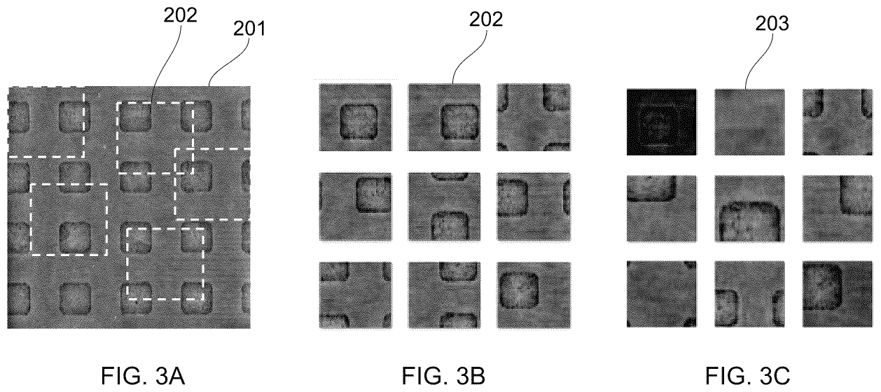

Turning to FIG. 3A, height image data 201 obtained from the sample scanning is shown. The height image data 201 comprises height measurements of an area of a surface of the sample, each height measurement being represented by a respective pixel.

The height image data 201 is divided into a plurality of height image patches 202. Each height image patch comprises height measurements of an area of the surface of the sample, each height measurement being represented by a respective pixel.

In FIG. 3A, five such height image patches can be seen. Each of the height image patches shown contains at least a portion of a feature. However, it is possible that some patches may not contain even a portion of a feature, i.e. these patches would show a featureless portion of the sample. Two of the height images patches 202 overlap and hence both contain a shared portion of the height image data 201. It is possible for more patches to overlap, or for no patches to overlap. Typically, fifty patches may be obtained per image.

A plurality of the features may have at least a portion of the feature contained in at least one of the height image patches. In the case of FIG. 3A twenty features are shown in the image data 201, and thirteen of these features have at least a portion of the feature contained in at least one of the height image patches 202.

Some of the height image patches 202 in FIG. 3A (in this case two of the height image patches 202) contain an entire feature. All of the five height image patches 202 in FIG. 3A contain a portion of a feature. Some of the height image patches 202 in FIG. 3A (in this case two of the height image patches 202) contain an entire feature and also a portion of another feature.

FIG. 3B shows a number of height image patches 202 obtained from the height image data 201. Some of the height image patches in FIG. 3B (in this case three of the height image patches 202) contain an entire feature. Some of the height image patches in FIG. 3B (in this case six of the height image patches 202) contain a portion of a feature.

One or more effects are applied to each of the height image patches to obtain a corresponding modified height image patch 203 for each height image patch, as can be seen in FIG. 3C. The one or more effects may include at least one of: a rotation; a reflection; applying noise; raising or lowering brightness; raising or lowering contrast; zooming in; and zooming out.

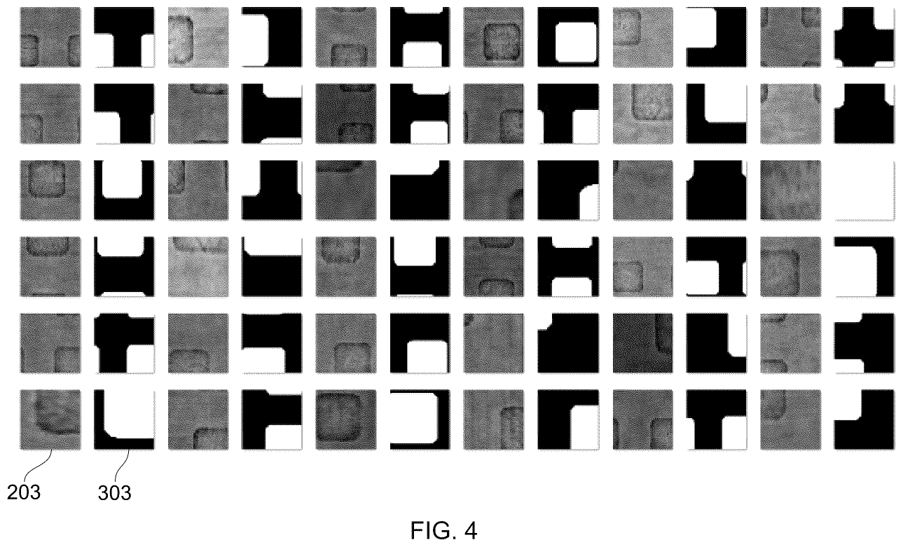

FIG. 4 shows a number of modified height images patches 203. As discussed above, each modified height image patch derives from a height image patch that has had one or more visual effects applied to it. The modified height image patches are used to train a neural network for the purpose of identifying feature data, and hence for segmenting height image data to identify feature data within the height image data.

Each modified height image patch is input into the neural network, and the neural network is used to identify any features or portions of features in the modified height image patch. The patches in which features have been identified (“identified patches” 303) are shown alongside their respective modified height image patches. In the identified patches 303, the feature data appears as white, while the non-feature data appears as black. For each identified patch 303, the neural network is scored based on how accurately the features are identified. The neural network may also be provided with the “answer”, i.e. the correct feature identification—the correct features are manually labelled if real data is being used, or are already known and automatically output if simulated data is being used (discussed further below). The neural network is trained using this scoring. For example, if the neural network scores well for a particular patch, it will “learn” that its identification for that patch was good, and that it should reinforce the identification patterns used for that patch. Conversely, if the neural network scores poorly for a given patch, its algorithm/code may be altered so as to more accurately identify features in the future. This alteration may be based on the correct feature identification.

Alternatively or additionally, the neural network may simply be provided with both the modified height image patches and the corresponding identified patches at the same time, in order to learn to correctly identify the features without a scoring system.

Although this embodiment has been described using real height image data that was obtained from a scan performed by a scanning probe microscope, it will be appreciated that the neural network could equally or additionally be trained using height image data that has been simulated by a computer. For example, the height image patches could be obtained using data generated by a computer simulation. In other words, simulated data is created using a computer model of the physical probe interaction against samples. Samples and structures are defined in code, and the scanning probe microscope interactions are simulated on the virtual sample. Alternatively, the height image patches could be a combination of real height image data and simulated height image data.

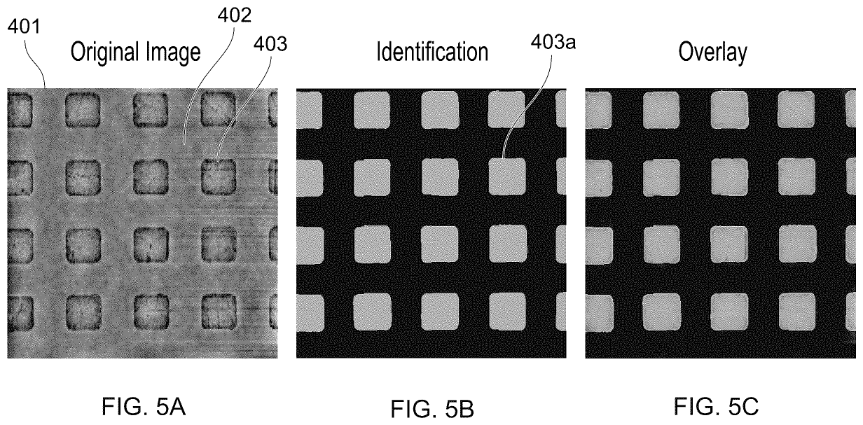

Turning to FIG. 5A, an image 401 formed from the height image data is shown. The height image data comprises feature data 403 corresponding to the one or more features of the sample. The features are columns that protrude from the sample surface, having a substantially square base when viewed from above. The height image data also comprises first region data 402 corresponding to a first region of the sample (i.e. non-feature data).

Once trained, the neural network segments the height image data so as to identify the feature data. In other words, the trained neural network receives the height image data as an input, and determines the portions of the image that correspond to the feature data 403 and the portions of the image that do not correspond to the feature data 403. These determinations mean that the neural network can identify the feature data 403.

FIG. 5B shows the result of the segmentation by the trained neural network. The neural network has identified the portions of the image that correspond to feature data 403. The portions corresponding to identified feature data 403a are shown in FIG. 5B.

The neural network can output a mask, using the identified feature data 403a. As shown in FIG. 5C, this can be overlayed over the height image data, such that the feature data 403 is masked and the first region data 402 remains unmasked. Following this, one or more processing steps can take place. For example, if the first region data 402 is known to be substantially flat, the image 401 can be masked as discussed above. A transformation can be determined based on the unmasked first region data and the knowledge of the flatness of the first region. This may be necessary if the first region data is not substantially flat due to an error in the scanning or the scanning equipment for example. The transformation can then be applied to the whole dataset in order to obtain corrected height image data.

The transformation may be a first order transformation, for example, in which an angled plane is transformed to a horizontal plane. Alternatively, the transformation may be a second order transformation or higher order transformation, in which a curved surface is transformed to a horizontal plane.

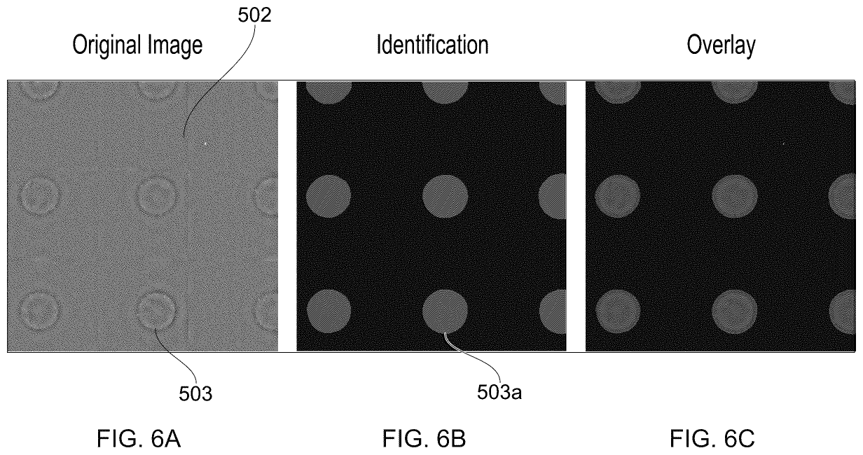

FIG. 6A shows an image resulting from a series of height image data obtained with a scanning probe microscope. As with the data shown in FIG. 5A, the height image data of FIG. 6A comprises first region data 502 and feature data 503 corresponding to a plurality of features. However, in this Figure the features in question are domes that protrude from the sample surface, rather than columns. The domes have a substantially circular base when viewed from above.

As with the previous embodiment, the trained neural network segments the height image data so as to identify the feature data. The result of this identification 503a is shown in FIG. 6B. An optional masking process is shown in FIG. 6C, as is discussed above.

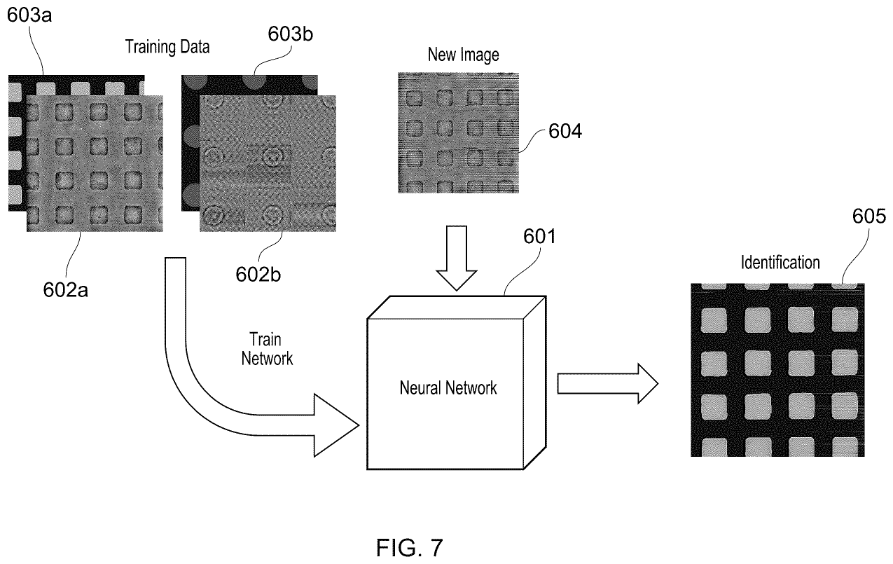

Turning now to FIG. 7, the training and use of the neural network 601 is shown. As has been described above, the neural network 601 receives images 602a, 602b as training inputs along with corresponding identifications 603a, 603b of any features within the images. These training inputs are used to train the neural network to identify feature data within height image data. As can be seen, both column features and dome features are provided as training inputs. Equally, further types of features/structures may be provided to the neural network as training inputs.

Specifically, though not shown in this Figure, the images 602a, 602b are provided to the neural network as modified height image patches 202, and the correctly identified images 603a, 603b may be provided at the same time as the modified height image patches 202, or afterwards, for scoring purposes or alongside a scoring result.

Following the training of the neural network to generate a trained neural network, a new sample is scanned with a probe microscope to obtain a series of height measurements of the new sample, as represented by a new image 604. The trained neural network is then operated to identify feature data in the series of height measurements of the new sample. For example the trained neural network 601 may segment the new image 604 to identify any feature data in the manner described above. This identification may be used to generate and output a mask 605.

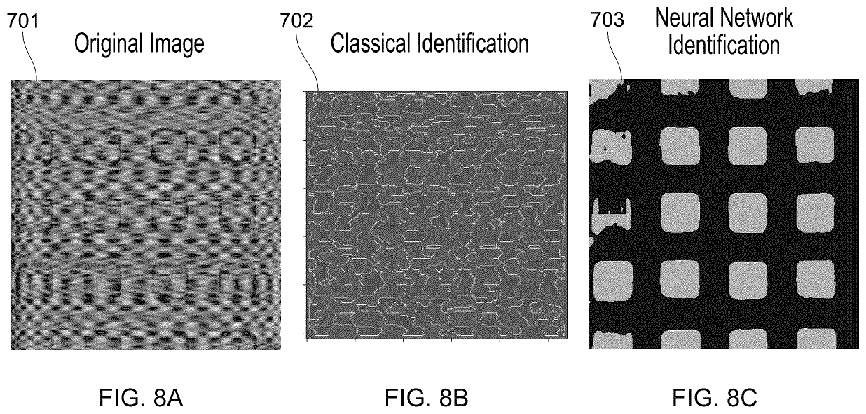

FIGS. 8A-C show the effectiveness of the segmentation technique when it is carried out by a trained neural network compared with when it is carried out using a more classical approach. The original image 701 shown in FIG. 8A displays a number of features, specifically columns, as with the image shown in FIG. 5A. However, in this example the image is highly obscured by noise. As such, the columns are more difficult to discern in this image than in the image shown in FIG. 5A.

FIG. 8B shows the result 702 of a classical method of segmenting the image. Such a classical method may involve identifying features by identifying portions of the height image data that exceed a given height threshold. Such a method be somewhat effective for height image data that does not have substantial levels of noise. However, given the high level of noise associated with the image of FIG. 8A, the result of the classical identification method is not reflective of the actual image, as can be seen in FIG. 8B.

In contrast, the segmentation 703 performed by the trained neural network using the method described above is shown in FIG. 8C. As can be seen this identification is a lot more accurate than the classical result.

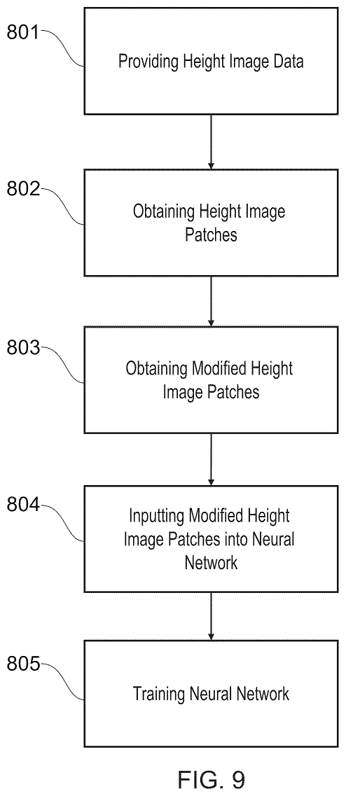

Turning now to FIG. 9, a flow chart illustrating the overall process of training the neural network is shown. Height image data comprising a series of height measurements of a sample is provided 801, the data comprising a plurality of features. From the height image data, a plurality of height image patches are obtained 802. At least some of the height image patches contain a portion of a feature. Modified height image patches are obtained by applying one or more effects to the height image patches 803, such that a corresponding modified height image patch is generated for each height image patch. The modified height image patches are input into the neural network 804. The neural network identifies any features in each of the inputted modified height image patches, and is trained based on this identification 805.

Although the invention has been described above with reference to one or more preferred embodiments, it will be appreciated that various changes or modifications may be made without departing from the scope of the invention as defined in the appended claims.

1. A method of training a neural network for use in surface metrology, comprising:
providing height image data comprising a series of height measurements of a sample, the height image data comprising a plurality of features;
obtaining, from the height image data, a plurality of height image patches, each height image patch containing at least a portion of a feature;
applying one or more effects to each of the height image patches to obtain a corresponding modified height image patch for each height image patch;
inputting one or more of the modified height image patches into the neural network;
using the neural network to identify a feature in each of the one or more modified height image patches; and
training the neural network based on the identification.

2. The method of claim 1, wherein the height image data comprises real data obtained from a real sample.

3. The method of claim 1, wherein the height image data comprises simulated data.

4. The method of claim 1, wherein the one or more effects comprise at least one of: a rotation; a reflection; applying noise; raising or lowering brightness; raising or lowering contrast; zooming in; and zooming out.

5. The method of claim 1, wherein the plurality of height image patches comprises 10000 or more height image patches.

6. The method of claim 5, wherein the plurality of height image patches comprises 15000 or more height image patches.

7. The method of claim 1, wherein the neural network is trained based on each of the modified height image patches.

8. The method of claim 1, wherein each height image patch comprises at least a corner, edge or central portion of a feature.

9. The method of claim 1, further comprising:
obtaining, from the height image data, a plurality of additional height image patches that do not contain a feature or a portion of a feature;
applying one or more effects to each of the additional height image patches to obtain a corresponding modified additional height image patch for each additional height image patch;
inputting one or more of the modified additional height image patches into the neural network;
using the neural network to determine that there are no features in each of the one or more modified additional height image patches; and
training the neural network based on the determination.

10. The method of claim 1, wherein each height image patch comprises height measurements of an area of a surface of the sample.

11. The method of claim 1, wherein a plurality of the features have at least a portion of the feature contained in at least one of the height image patches.

12. The method of claim 1, wherein some of the height image patches contain an entire feature and some of the height image patches contain a portion of a feature.

13. The method of claim 1, wherein the height image data comprises probe microscope data.

14. A method of performing surface metrology of a sample, the method comprising: training a neural network by a method according to claim 1, thereby generating a trained neural network; scanning a new sample to obtain a series of height measurements of the new sample; and operating the trained neural network to identify feature data in the series of height measurements of the new sample.

15. Apparatus for training a neural network for use in surface metrology, comprising a processor configured to perform the method of claim 1.

16. A computer-readable medium that, when read by a computer, causes the computer to perform the method of claim 1.
